(19) United States
(12) Patent Application Publication
(10) Pub. No.: US 2013/0024189 A1
(43) Pub. Date: Jan. 24, 2013

(54) MOBILE TERMINAL AND DISPLAY METHOD THEREOF

(71) Applicants: Jaemin KIM, Seoul (KR); Seungho HAN, Seoul (KR); Yongchul PARK, Seoul (KR)

(72) Inventors: Jaemin KIM, Seoul (KR); Seungho HAN, Seoul (KR); Yongchul PARK, Seoul (KR)

(73) Assignee: LG ELECTRONICS INC., Seoul (KR)

(21) Appl. No.: 13/239,558

(22) Filed: Sep. 22, 2011

Related U.S. Application Data
(63) Continuation of application No. PCT/KR2011/005453, filed on Jul. 22, 2011.

(51) Int. Cl. G10L 13/00

(52) U.S. Cl. 704/201; 704/E13.001

(57) ABSTRACT

A mobile terminal and a control method thereof are provided. The mobile terminal includes: an audio output module; a memory storing text; and a controller configured to convert at least a portion of the text into a speech and output the speech through the audio output module, wherein the controller stores at least a portion of speech data obtained by converting the at least a portion of the text into the speech in the memory, and outputs the speech based on the stored speech data to the audio output module when a speech output signal with respect to the at least portion of the text is obtained. When speech output signal with respect to a portion which has been output by speech is obtained, speech is output based on the stored speech data, thereby shortening time required for outputting the speech.

This nonprovisional application claims priority under 35 U.S.C. §119(a) and 35 U.S.C. §120 on Patent Application No. PCT/KR2011/005453 filed on Jul. 22, 2011, the entire contents of which are hereby incorporated by reference.

### BACKGROUND

1. Field

This document relates to a mobile terminal for outputting a speech based on stored speech data when a speech output signal with respect to a portion which has been previously output by speech is obtained, thus shortening time required for outputting the speech, and a control method thereof.

2. Related Art

As the functions of terminals such as personal computers, laptop computers, cellular phones and the like are diversified, the terminals are constructed in the form of a multimedia player having multiple functions of capturing pictures or moving images, playing music, moving image files and games and receiving broadcasting programs.

Terminals can be divided into mobile terminals and stationary terminals. The mobile terminals can be classified into handheld terminals and vehicle mount terminals according to whether users can personally carry the terminals.

To support and enhance functions of a terminal, it can be considered to improve a structural part and/or a software part of the terminal.

A variety of recent terminals including mobile terminals provide more complex and various functions.

### SUMMARY

An aspect of the present invention provides a mobile terminal for outputting a speech based on stored speech data when a speech output signal with respect to a portion which has been previously output by speech is obtained, thus shortening time required for outputting the speech, and a control method thereof.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to an embodiment of this document.

FIG. 2 is a view showing a TTS system of a mobile terminal according to an embodiment of this document.

FIGS. 3 and 4 are views showing a unit-selection process in the TTS system of FIG. 2.

FIG. 5 is a flow chart illustrating a process of operating a mobile terminal according to this document.

FIG. 6 is a view showing a state in which text is displayed on the mobile terminal of FIG. 5.

FIG. 7 is a view showing a state in which a TTS operation performed in the mobile terminal of FIG. 5.

FIGS. 8 to 10 are views showing a process of re-outputting speech, which has been already output from the mobile terminal of FIG. 5.

FIG. 11 is a graph showing the effect according to the mobile terminal of FIG. 5.

FIGS. 12 to 22 are views showing operations corresponding to manipulations with respect to the mobile terminal of FIG. 5.

FIGS. 23 and 24 are views showing manipulations with respect to a setting of the mobile terminal of FIG. 5.

FIGS. 25 to 27 are views showing operations of the mobile terminal of FIG. 5.

FIG. 28 is a view showing an operation related to a battery of the mobile terminal of FIG. 5.

### DETAILED DESCRIPTION OF THE PREFERRED EMBODIMENTS

This document will now be described more fully with reference to the accompanying drawings, in which exemplary embodiments of this document are shown. This document may, however, be embodied in many different forms and should not be construed as being limited to the embodiments set forth herein; rather, there embodiments are provided so that this disclosure will be thorough and complete, and will fully convey the concept of this document to those skilled in the art.

Hereinafter, a mobile terminal relating to this document will be described below in more detail with reference to the accompanying drawings. In the following description, suffixes such as ‘module’ and ‘unit’ are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system and so on.

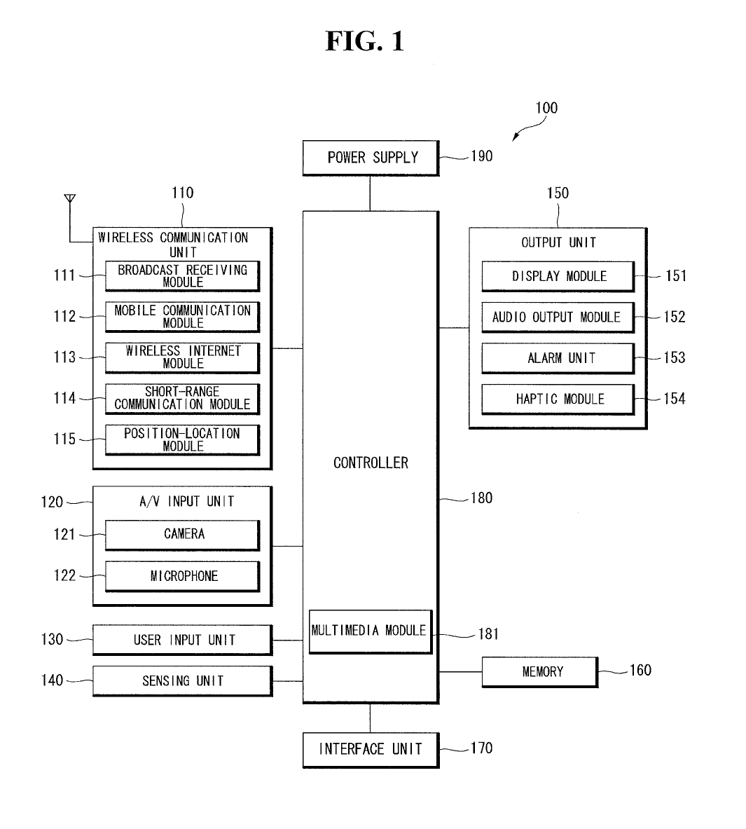

FIG. 1 is a block diagram of a mobile terminal 100 according to an embodiment of this document. Other embodiments, configurations and arrangements may also be provided. As shown, the mobile terminal 100 may include a radio communication unit 110, an audio/video (A/V) input unit 120, a user input unit 130, a sensing unit 140, an output unit 150, a memory 160, an interface 170, a controller 180, and a power supply 190. Not all of the components shown in FIG. 1 may be essential parts and the number of components included in the mobile terminal 100 may be varied. The components of the mobile terminal 100 will now be described.

The radio communication unit 110 may include at least one module that enables radio communication between the mobile terminal 100 and a radio communication system or between the mobile terminal 100 and a network in which the mobile terminal 100 is located. For example, the radio communication unit 110 may include a broadcasting receiving module 111, a mobile communication module 112, a wireless Internet module 113, a local area communication module 114, and a location (or position) information module 115.

The broadcasting receiving module 111 may receive broadcasting signals and/or broadcasting related information from an external broadcasting management server through a broadcasting channel. The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal.

The broadcasting signals may include not only TV broadcasting signals, radio broadcasting signals, and data broadcasting signals but also signals in the form of a combination of a TV broadcasting signal and a radio broadcasting signal. The broadcasting related information may be information on a broadcasting channel, a broadcasting program or a broadcasting service provider, and may be provided even through a mobile communication network. In the latter case, the broadcasting related information may be received by the mobile communication module 112.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. More particularly, the broadcasting receiving module 111 may receive digital broadcasting signals using digital broadcasting systems such as a digital multimedia broadcasting-terrestrial (DMB-T) system, a digital multimedia broadcasting-satellite (DMB-S) system, a media forward link only (MediaFLO) system, a DVB-H and integrated services digital broadcast-terrestrial (ISDB-T) systems. The broadcasting receiving module 111 may receive signals from broadcasting systems providing broadcasting signals other than the above-described digital broadcasting systems.

The broadcasting signals and/or broadcasting related information received through the broadcasting receiving module 111 may be stored in the memory 160. The mobile communication module 112 may transmit/receive a radio signal to/from at least one of a base station, an external terminal and a server on a mobile communication network. The radio signal may include a voice call signal, a video telephony call signal or data in various forms according to transmission and reception of text/multimedia messages.

The wireless Internet module 113 may correspond to a module for wireless Internet access and may be included in the mobile terminal 100 or may be externally attached to the mobile terminal 100. Wireless LAN (WLAN or Wi-Fi), wireless broadband (Wibro), world interoperability for microwave access (Wimax), high speed downlink packet access (HSDPA) and so on may be used as a wireless Internet technique.

The local area communication module 114 may correspond to a module for local area communication. Further, Bluetooth®, radio frequency identification (RFID), infrared data association (IrDA), ultra wideband (UWB) and/or ZigBee® may be used as a local area communication technique.

The location information module 115 may confirm or obtain the position of the mobile terminal 100. The position information module 115 may obtain position information by using a global navigation satellite system (GNSS). The GNSS is a terminology describing a radio navigation satellite system that revolves around the earth and transmits reference signals to predetermined types of radio navigation receivers such that the radio navigation receivers can determine their positions on the earth's surface or near the earth's surface. The GNSS may include a global positioning system (GPS) of the United States, Galileo of Europe, a global orbiting navigational satellite system (GLONASS) of Russia, COMPASS of China, and a quasi-zenith satellite system (QZSS) of Japan among others.

A global positioning system (GPS) module is a representative example of the location information module 115. The GPS module 115 may calculate information on distances between one point or object and at least three satellites and information on a time when the distance information is measured and apply trigonometry to the obtained distance information to obtain three-dimensional position information on the point or object according to latitude, longitude and altitude at a predetermined time.

A method of calculating position and time information using three satellites and correcting the calculated position and time information using another satellite may also be used. In addition, the GPS module 115 may continuously calculate the current position in real time and calculate velocity information using the location or position information.

As shown in FIG. 1, the A/V input unit 120 may input an audio signal or a video signal and include a camera 121 and a microphone 122. The camera 121 may process image frames of still images or moving images obtained by an image sensor in a video telephony mode or a photographing mode. The processed image frames may be displayed on a display 151 which may be a touch screen.

The image frames processed by the camera 121 may be stored in the memory 160 or may be transmitted to an external device through the radio communication unit 110. The mobile terminal 100 may also include at least two cameras 121.

The microphone 122 may receive an external audio signal in a call mode, a recording mode or a speech recognition mode and process the received audio signal into electric audio data. The audio data may then be converted into a form that can be transmitted to a mobile communication base station through the mobile communication module 112 and output in the call mode. The microphone 122 may employ various noise removal algorithms (or noise canceling algorithm) for removing or reducing noise generated when the external audio signal is received.

The user input unit 130 may receive input data for controlling operation of the mobile terminal 100 from a user. The user input unit 130 may include a keypad, a dome switch, a touch pad (constant voltage/capacitance), a jog wheel, a jog switch and so on.

The sensing unit 140 may sense a current state of the mobile terminal 100, such as an open/close state of the mobile terminal 100, a position of the mobile terminal 100, whether a user touches the mobile terminal 100, a direction of the mobile terminal 100, and acceleration/deceleration of the mobile terminal 100, and generate a sensing signal for controlling operation of the mobile terminal 100. For example, in case of a slide phone, the sensing unit 140 may sense whether the slide phone is opened or closed. Further, the sensing unit 140 may sense whether the power supply 190 supplies power and/or whether the interface 170 is connected to an external device. The sensing unit 140 may also include a proximity sensor 141.

The output unit 150 may generate visual, auditory and/or tactile output and may include the display 151, an audio output module 152, an alarm 153 and a haptic module 154. The display 151 may display information processed by the mobile terminal 100. The display 151 may display a user interface (UI) or a graphic user interface (GUI) related to a telephone call when the mobile terminal 100 is in the call mode. The display 151 may also display a captured and/or received image, a UI or a GUI when the mobile terminal 100 is in the video telephony mode or the photographing mode.

In addition, the display 151 may include at least one of a liquid crystal display, a thin film transistor liquid crystal display, an organic light-emitting diode display, a flexible display and a three-dimensional display. Some of these displays may be of a transparent type or a light transmissive type. That is, the display 151 may include a transparent display.

The transparent display may include a transparent liquid crystal display. The rear structure of the display 151 may also be of a light transmissive type. Accordingly, a user may see an object located behind the body of the mobile terminal 100 through the transparent area of the body of the mobile terminal 100 that is occupied by the display 151.

The mobile terminal 100 may also include at least two displays 151. For example, the mobile terminal 100 may include a plurality of displays 151 that are arranged on a single face at a predetermined distance or integrated displays. The plurality of displays 151 may also be arranged on different sides.

Further, when the display 151 and a sensor sensing touch (hereafter referred to as a touch sensor) form a layered structure that is referred to as a touch screen, the display 151 may be used as an input device in addition to an output device. The touch sensor may be in the form of a touch film, a touch sheet, and a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 may detect a touched portion of the display 151.

The proximity sensor 141 of the sensing unit 140 may be located in an internal region of the mobile terminal 100, surrounded by the touch screen, or near the touch screen. The proximity sensor 141 may sense an object approaching a predetermined sensing face or an object located near the proximity sensor using an electromagnetic force or infrared rays without having mechanical contact. The proximity sensor 141 may have a lifetime longer than a contact sensor and may thus have a wide application in the mobile terminal 100.

The proximity sensor 141 may include a transmission type photo-electric sensor, a direct reflection type photo-electric sensor, a mirror reflection type photo-electric sensor, a high-frequency oscillating proximity sensor, a capacitive proximity sensor, a magnetic proximity sensor, and/or an infrared proximity sensor. A capacitive touch screen may be constructed such that proximity of a pointer is detected through a variation in an electric field according to the proximity of the pointer. The touch screen (touch sensor) may be classified as a proximity sensor 141.

For ease of convenience of explanation, an action of the pointer approaching the touch screen without actually touching the touch screen may be referred to as a proximity touch and an action of bringing the pointer into contact with the touch screen may be referred to as a contact touch. The proximity touch point of the pointer on the touch screen may correspond to a point of the touch screen at which the pointer is perpendicular to the touch screen.

The proximity sensor 141 may sense the proximity touch and a proximity touch pattern (e.g., a proximity touch distance, a proximity touch direction, a proximity touch velocity, a proximity touch time, a proximity touch position, a proximity touch moving state, etc.). Information corresponding to the sensed proximity touch action and proximity touch pattern may then be displayed on the touch screen.

The audio output module 152 may output audio data received from the radio communication unit 110 or stored in the memory 160 in a call signal receiving mode, a telephone call mode or a recording mode, a speech recognition mode and a broadcasting receiving mode. The audio output module 152 may output audio signals related to functions, such as a call signal incoming tone and a message incoming tone, performed in the mobile terminal 100. The audio output module 152 may include a receiver, a speaker, a buzzer, and the like. The audio output module 152 may output sounds through an earphone jack. The user may hear the sounds by connecting an earphone to the earphone jack.

The alarm 153 may output a signal for indicating generation of an event of the mobile terminal 100. For example, alarms may be generated when receiving a call signal, receiving a message, inputting a key signal, or inputting touch. The alarm 153 may also output signals in forms different from video signals or audio signals, for example, a signal for indicating generation of an event through vibration. The video signals or the audio signals may also be output through the display 151 or the audio output module 152.

The haptic module 154 may generate various haptic effects that the user can feel. One example of the haptic effects is vibration. The intensity and/or pattern of vibration generated by the haptic module 154 may also be controlled. For example, different vibrations may be combined and output or may be sequentially output.

The haptic module 154 may generate a variety of haptic effects including an effect of stimulus according to an arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 may not only transmit haptic effects through direct contact but may also allow the user to feel haptic effects through a kinesthetic sense of the user's fingers or arms. The mobile terminal 100 may also include a plurality of haptic modules 154.

The memory 160 may store a program for operation of the controller 180 and temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk or an optical disk. The mobile terminal 100 may also operate in relation to a web storage performing the storing function of the memory 160 on the Internet.

The interface 170 may serve as a path to external devices connected to the mobile terminal 100. The interface 170 may receive data from the external devices or power and transmit the data or power to internal components of the mobile terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The interface 170 may also interface with a user identification module that is a chip that stores information for authenticating authority to use the mobile terminal 100. For example, the user identification module may be a user identify module (UIM), a subscriber identify module (SIM) and a universal subscriber identify module (USIM). An identification device including the user identification module may also be manufactured in the form of a smart card. Accordingly, the identification device may be connected to the mobile terminal 100 through a port of the interface 170.

The interface 170 may also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle may be used as signals for confirming whether the mobile terminal 100 is correctly set in the cradle.

The controller 180 may control overall operations of the mobile terminal 100. For example, the controller 180 may perform control and processing for voice communication, data communication and/or video telephony. The controller 180 may also include a multimedia module 181 for playing multimedia. The multimedia module 181 may be included in the controller 180 as shown in FIG. 1 or may be separated from the controller 180.

The controller 180 may perform a pattern recognition process capable of recognizing handwriting input or picture-drawing input applied to the touch screen as characters or images. The power supply 190 may receive external power and internal power and provide power required for operations of the components of the mobile terminal 100 under control of the controller 180.

According to hardware implementation, embodiments of the present disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. The embodiments may be implemented by the controller 180.

According to software implementation, embodiments such as procedures or functions may be implemented with a separate software module executing at least one function or operation. Software codes may be implemented according to a software application written in an appropriate software language. The software codes may be stored in the memory 160 and executed by the controller 180.

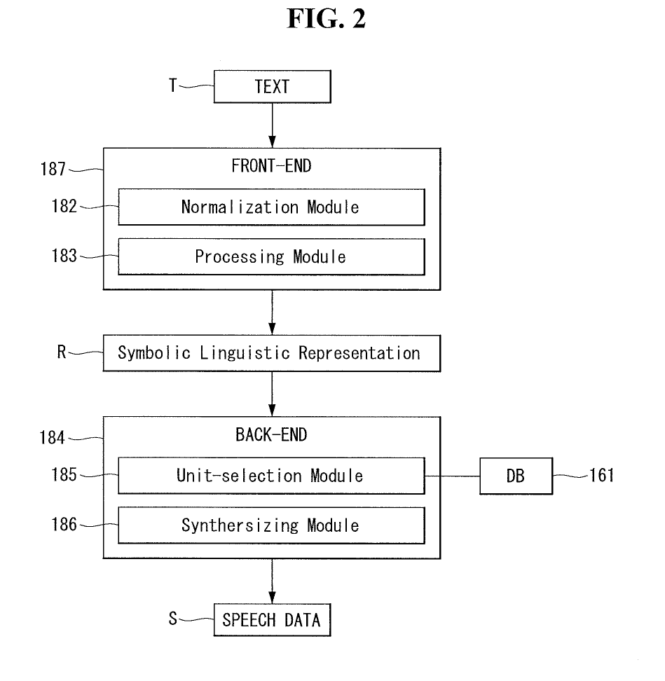

FIG. 2 is a view showing a TTS (Text-To-Speech) system of a mobile terminal according to an embodiment of this document.

As shown in FIG. 2, the mobile terminal 100 according to an embodiment of the present invention may output text by speech through the TTS system.

The TTS system is a system for changing selected text into a speech and output the speech. The TTS system may be used for a spoken dialog system service, a call center service, a voice enabled Web service, an e-mail service, and the like. Also, like the mobile terminal 100 according to an embodiment of the present invention, the TTS system may change text into speech and output the speech.

In the mobile terminal 100, the TTS system may be used in the following cases. For example, when the TTS system operates in a state in which text is selected, the user can check content of the text by speech without having to check the text with his eyes. Thus, the user can check the desired text while driving or working. The TTS system may include a front-end part 187 and a back-end part 184.

The front-end part 187 may be a part for receiving text (T) and outputting a symbolic linguistic representation (R). The front-end part 187 may include a normalization module 182 and a processing module 183.

The normalization module 182 may check a plural form, a past tense, or the like, of input text (T) and perform morphological analysis to convert a monetary unit, a number unit, an abbreviation, or the like, into a readable word. Also, the normalization module 182 may perform a syntactic-semantic analysis, check parts of speech (POS), or estimate a syntactic-semantic structure of a sentence.

The processing module 183 may perform an operation of specializing words into a phrase based on a syntactic-semantic structure of a character. Also, the processing module 183 may estimate a semantics features including stress, accent, and a focus.

The back-end part 184 may receive a symbolic linguistic representation (R), the results of the front-end part 187, and output speech data (S). The back-end part 183 may include a unit-selection module 185 and a synthesizing module 186.

The unit-selection module 185 may select units from the database 161 based on the symbolic linguistic representation (R). The unit-selection module 185 may appropriately dispose the selected units to create a data structure to output the same as speech.

The DB 161 may be an aggregate of recorded speech units. The BS may include recorded speeches classified by phone, diphone between phones, syllable, morpheme, word, phrase, clause, sentence, and the like. The classified speech units may undergo a correction process by using a waveform or spectrogram method. An index may be matched to each speech unit of the DB 161. The index may be formed based on parameters based on a pitch, a duration, a position at a syllable, a relationship with an adjacent speech, and the like. In the synthesizing of a speech using the unit-selection module, a natural speech can be created as the DB 161 is larger.

The synthesizing module 186 may adjust a pitch, a phoneme duration, or the like, of a data structure of a unit selected by the unit-selection module 185. A speech synthesized through the synthesizing module 186 may be processed to be more natural and intelligible.

Speech data (S) may be the results of the back-end part 184. The speech data (S) may be transmitted to the audio output module (152 in FIG. 1) of the mobile terminal 100 and may be output as a speech recognized through a hearing organ.

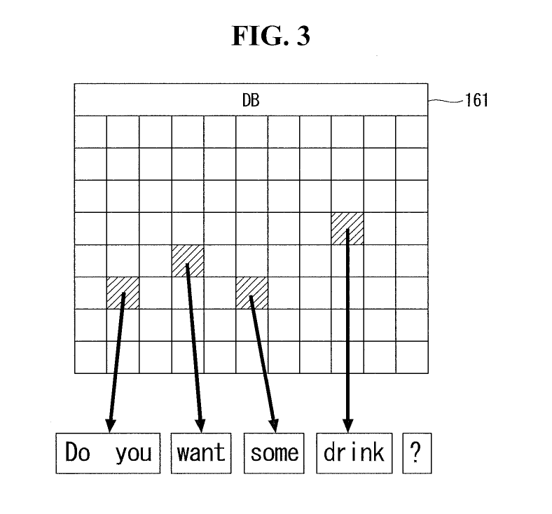

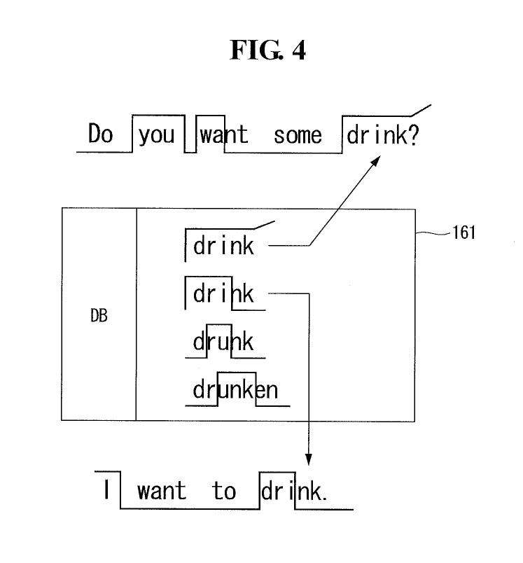

FIGS. 3 and 4 show a unit-selection process in the TTS system of FIG. 2.

As shown in FIGS. 3 and 4, the unit-selection module 185 of the mobile terminal according to an embodiment of the present invention may select an appropriate speech unit from the DB 161.

As shown in FIG. 3, the DB 161 may include a plurality of speech units which were previously recorded. For example, text of “Do you want some drink?” may be input. The unit-selection module 186 may select an appropriate speech from among a phone constituting the text, a diphone between phones, a syllable, a morpheme, a word, a phrase, and a sentence. Namely, it means that the unit-selection module 185 may select a speech corresponding to ‘want’, ‘some’, ‘drink’ from the DB 161 or may select a phrase ‘do you’ to create a speech data structure.

As shown in FIG. 4, in the unit selection, the position of a word may be considered in the text.

The DB 161 may include a speech having various intonations. The intonation may be different even in case of an identical word. For example, in case of ‘drink’, its intonation is up at an end portion of an interrogative sentence, and the intonation is down in case of a declarative sentence. Also, the intonation may be changed in case of the past tense and a past particle tense.

The unit-selection module 185 may selectively combines speeches which can be optimal to a corresponding sentence in various speeches included in the DB 161, to thus create a data structure of a natural, intelligible speech.

The data structure of a speech using the unit-selection module 185 is formed through a process of selecting particular speeches from the large quantity DB 161 and combining them, requiring a relatively long period of time. Namely, it means that, in the process of generating speech data (S) using the TTS, a long period of time and a great deal of resources are required in combining speeches by the unit-selection module 185.

When a long period of time and a great deal of resources are required, certain delay may occur in outputting the text by speech. Delay generated in the process of outputting the text by speech may be classified into some parts as follows. First, delay may be generated in the process of outputting speech by first using the TTS. Second, delay may be generated in the process of shifting from a portion currently being reproduced to output speech of a different portion in the process of outputting speech. The mobile terminal according to an embodiment of the present invention may store the generated speech data to a degree. Thus, when the identical portion is intended to be output again, the previously generated and stored speech data may be used. When the stored speech data is used, the unit-selection process, or the like, may be omitted, and accordingly, delay felt by the user can be considerably reduced.

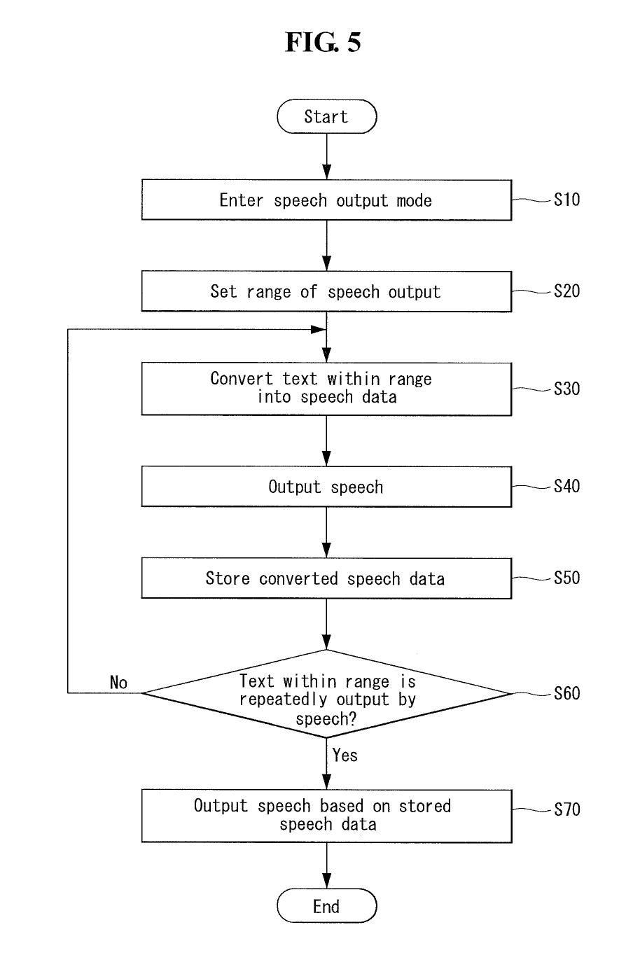

FIG. 5 is a flow chart illustrating a process of operating the mobile terminal according to this document.

As illustrated, the controller 180 of the mobile terminal 100 according to an embodiment of the present invention may perform step S10 of entering a speech output mode.

As described above, the speech output mode may be a mode in which the sequential process of converting the text (T) into speech data (S) and outputting the same to the audio output module 152 is performed. The speech output mode may be executed by selecting a particular menu by the user or by a control signal from the controller 180.

When the speech output mode is entered, step S20 of setting the range of a speech output may be performed.

The range of a speech output may be the entirety or a portion of the selected text (T). The text (T) may have been stored in the memory 160 of the mobile terminal 100.

The memory 160 may be various units for storing data permanently, semi-permanently, or temporarily. It means that, for example, the memory 160 may be a concept including a recording medium used to store particular text data permanently or semi-permanently in the mobile terminal 100 or a recording medium used to temporarily store and soon remove particular text data obtained through the wireless communication unit 110 or the interface unit 170. The range of the memory 160 may be the same in the following.

The range of a speech output may be determined by a control operation of the controller 180 or according to a user selection. For example, the user may perform a touch operation to select a particular portion of the text. This will be described at a corresponding part in detail later.

Step S30 of converting text within the range into speech data may be performed.

As described above, the step of converting text into speech data may be performed through the front-end part 187 and the back-end part 184.

The process of operating the mobile terminal may include step S40 of outputting speech and step S50 of storing the converted speech data.

The controller 180 may transmit the speech data to the audio output module 152 to allow the user to recognize the speech through a hearing organ. Also, the controller 180 may store the converted speech data in the memory 160.

Step S60 of determining whether to output speech by repeating the text within the range and step S70 of outputting speech based on the stored speech data when it is determined that the speech is output repeatedly may be performed.

The speech-converted text may be repeatedly output according to a control signal from the controller 180 or a user selection. For example, it is assumed that the text includes A, B, C, and D, and the parts A, B, and C have been already output by speech. It is also assumed that the user wants to listen to the part A in this situation.

When a signal for outputting the part A again is input, the controller 180 may output the speech by using the stored speech data. Namely, this means that the TTS process including a unit selection may not be performed again. Because the TTS process is not performed again, a time required for outputting the speech can be shortened. Accordingly, the effect that the usability of the mobile terminal 100 is improved can be expected.

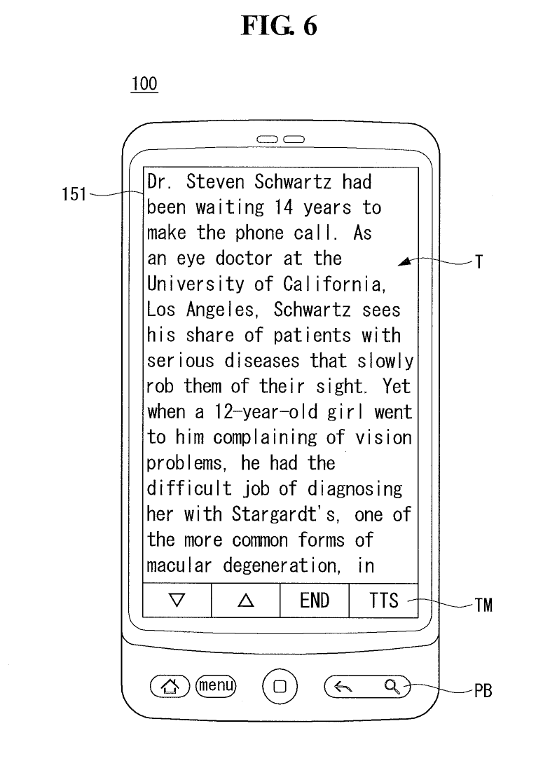

FIG. 6 is a view showing a state in which text is displayed on the mobile terminal of FIG. 5.

As illustrated, the controller 180 of the mobile terminal 100 according to an embodiment of the present invention may display the text (T) on the display module 151. The text (T) may include various contents displayed as characters such as a particular document stored by the user, a Web page, a text message, an e-mail, or the like.

The controller 180 may display a speech conversion button (TM). The speech conversion button (TM) may be selectively displayed when the text (T) is displayed on the display module 151. It means that, for example, the speech conversion button (TM) may be configured in the form of a hidden menu which is not displayed at a usual time but displayed when the text (T) is displayed. When the speech conversion button (TM) is selected, the displayed text (T) may be output by speech.

The speech output of the text (T) may be performed by a button provided on the mobile terminal 100. For example, when a function selection button (PB) of the mobile terminal 100 is pressed, the speech conversion function may be executed. By configuring such that a speech output is made by using the function selection button (PB) providing a physical tactile sensation, the user can execute the speech output function without having to view the display module 151 of the mobile terminal.

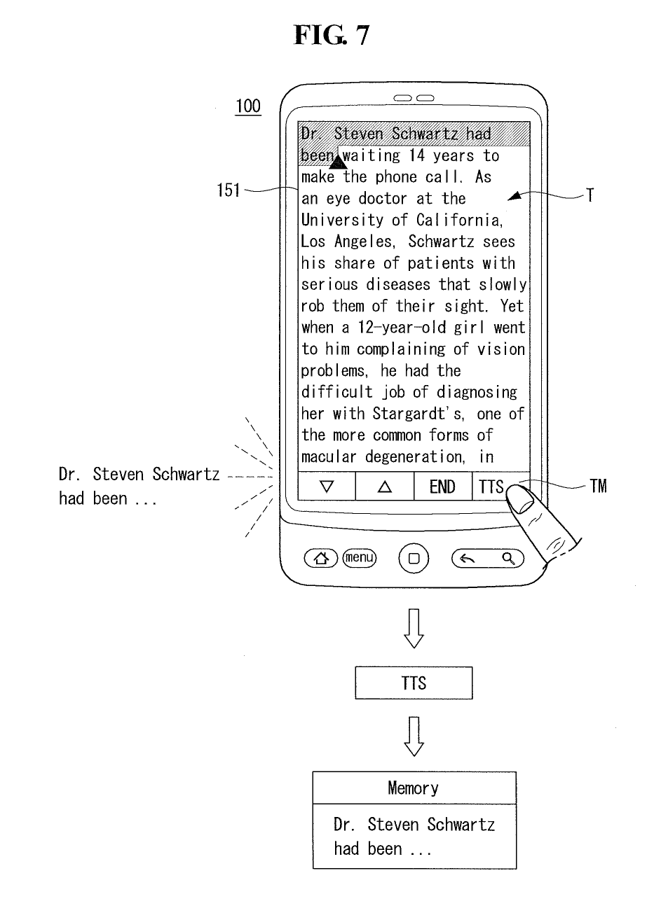

FIG. 7 is a view showing a state in which a TTS operation performed in the mobile terminal of FIG. 5.

As illustrated, the mobile terminal 100 according to an embodiment of the present invention may perform the speech output function.

When the user selects the speech conversion button (TM) by using his finger (F), or the like, the speech output function may be executed. Namely, it means that the text (T) selected by the controller 180 can be TTS-converted so as to be output by speech.

The speech may be output to the audio output module 152 of the mobile terminal 100. Since the text (T) is output by speech, the user can recognize the text (T) while driving or working.

As the text (T) is output by speech, the speech data may be stored in the memory 160.

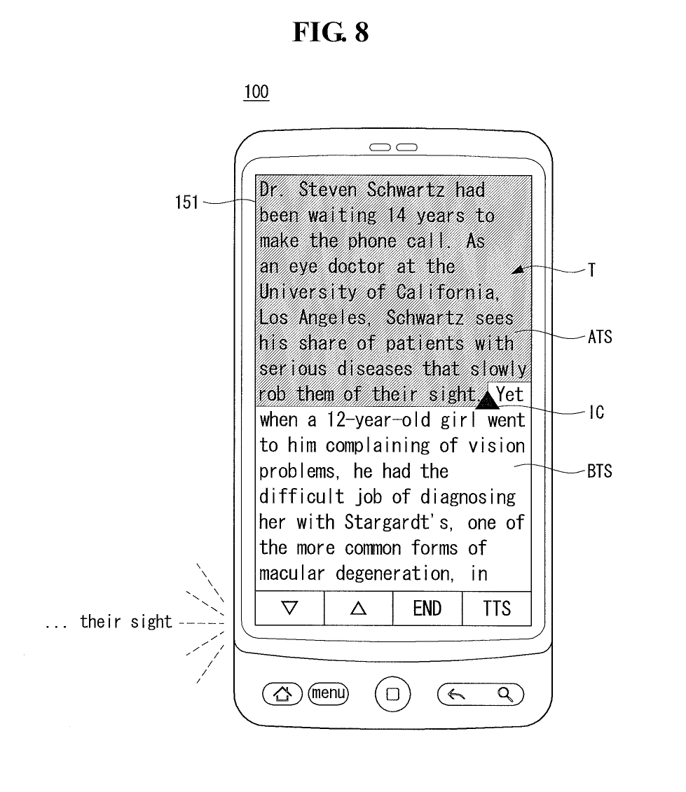

FIGS. 8 to 10 are views showing a process of re-outputting speech, which has been already output from the mobile terminal of FIG. 5.

As shown in FIGS. 8 to 10, the controller 180 of the mobile terminal according to an embodiment of the present invention may display an indicator IC indicating a current location output by speech. Also, the controller 180 may display an output portion ATS output by speech and a non-output part BTS such that they are discriminated from one other.

The indicator IC may move along a point at which speech is currently output. Namely, when speech is output, the position of the indicator IC may be continuously moved. Since the indicator IC is displayed, the user can visually recognize a current output position.

The output portion ATS and the non-output portion BTS may be displayed to have a different color, brightness, and the like. For example, the controller 180 may display the output portion ATS, which has been already output by speech, to be darker, and the non-output portion BTS, which is not output yet, to be brighter.

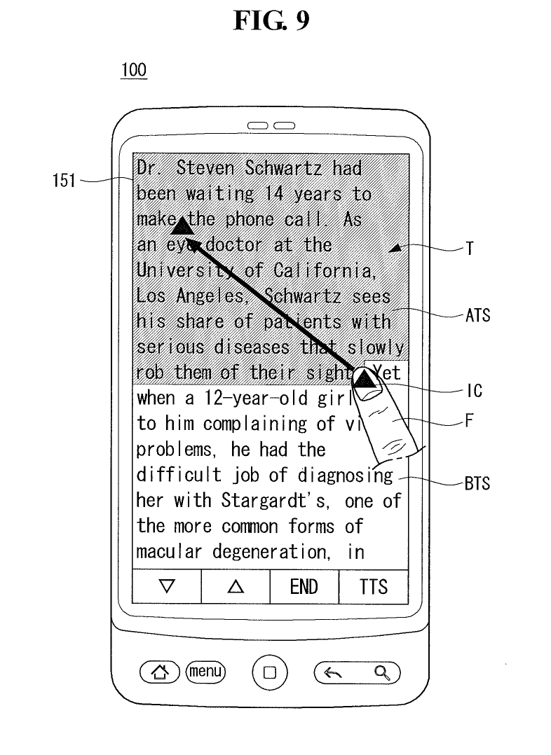

As shown in FIG. 9, the mobile terminal 100 according to an embodiment of the present invention may change a reproduced position by a user's touch operation.

The user may change the position of the indicator IC with his finger (F) or the like. It means, for example, that the user may touch the indictor IC and drag it to a particular portion of the output portion ATS which has been already reproduced. When the user performs the touch-and-drag operation, the indicator IC can be moved accordingly.

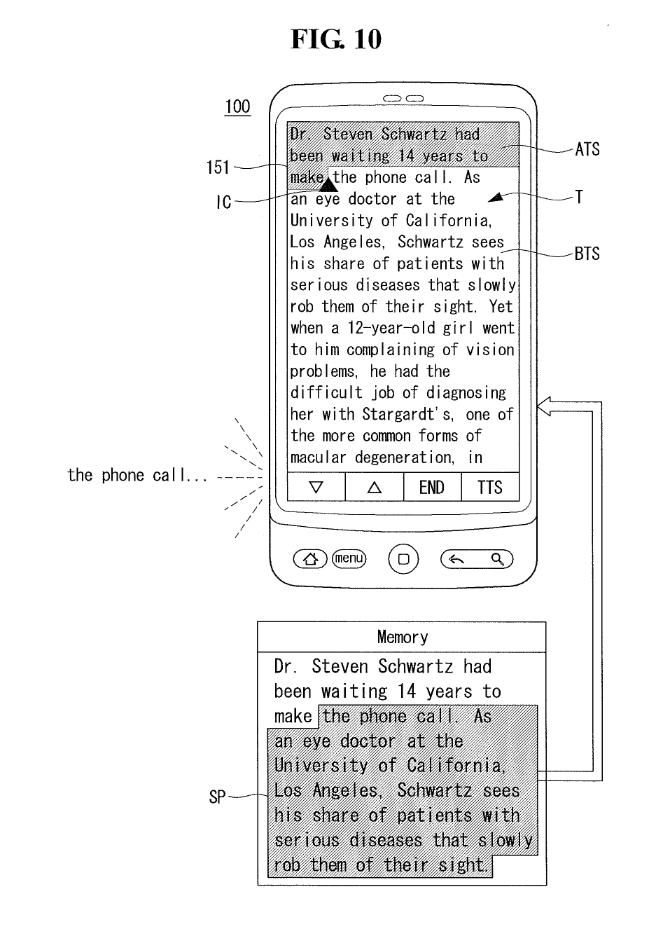

As shown in FIG. 10, when the indicator is moved to the particular position, the controller 180 may output speech starting from the position to which the indicator IC is currently positioned.

The portion output by the controller 180 may be a portion which has been already output before. When the particular portion selected by the user is a portion which has been already output before, the controller 180 may search for the speech data stored in the memory 160.

The speech data which has been converted through the TTS process may be stored in the memory 160. The controller 180 may output the portion selected from the speech data stored in the memory 160 by the user again. Since TTS is not required to be performed again on the user selected portion, time delay required for outputting the speech of the corresponding portion can be reduced.

The reduction in the time delay can be clearly understood when a case in which the corresponding portion is newly converted into speech because of the absence of corresponding speech data is considered. According to the mobile terminal 100 according to an embodiment of the present invention, since the process of newly converting the user selected portion into speech is not required, the fast responsiveness can contribute to spreading of a speech service demand using the mobile terminal 100.

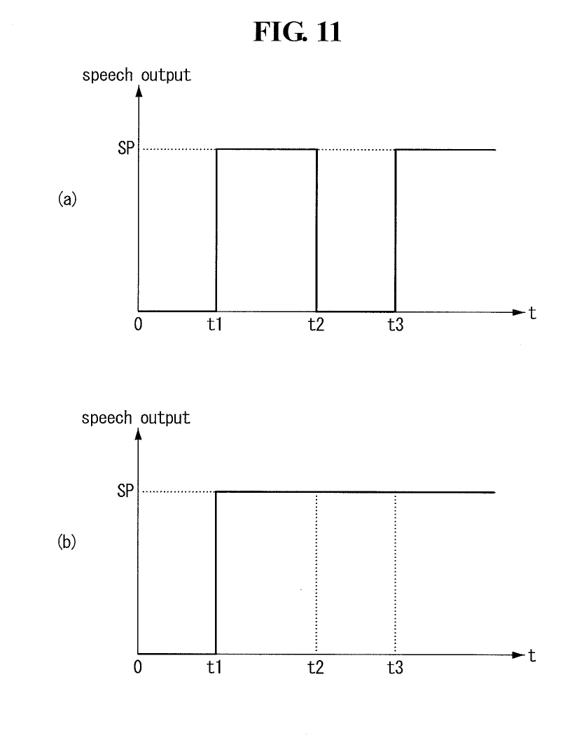

FIG. 11 is a graph showing the effect according to the mobile terminal of FIG. 5.

As shown in FIG. 11, the mobile terminal according to an embodiment of the present invention can exhibit the effect of the reduction in time delay compared with the related art.

As shown in FIG. 11(a), the user may select the function of outputting speech using the TTS function at a particular point in time. When the user selects the function of outputting speech at a particular point in time, the controller 180 may make preparations for outputting speech until a point in time t1.

When the controller 180 is ready for outputting speech at the point in time t1, a speech output (SP) may be performed. The speech output SP may continue up to a point in time t2 at which the user performs inputting to output speech again starting from a particular point in time in the past.

When the user performs inputting to output speech again starting from a particular point in time in the past, in the related art, preparations for outputting speech must be made again. Then, a speech output is not made from the point in time t2 to a point in time t3, potentially causing delay.

At the point in time t3, when preparations for the speech output SP are completed, the controller 180 may output speech.

As shown in FIG. 11(b), in the mobile terminal 100 according to an embodiment of the present invention, even when the user selects a previously output portion at the point in time t2 while speech is being output, time delay substantially does not occur. Namely, since the TTS process is not newly performed to output speech and the previously converted speech data is used, time delay can be minimized. Thus, the user of the mobile terminal 100 can move to a particular point in time and output corresponding speech again, without feeling inconvenience.

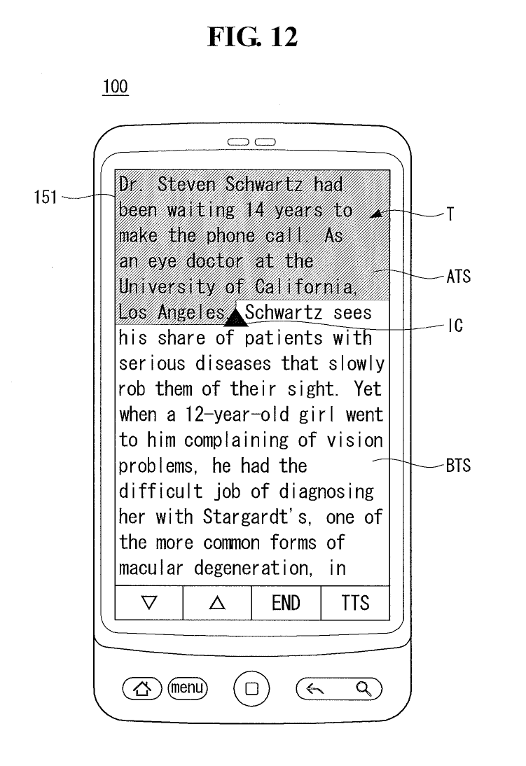

FIGS. 12 to 22 are views showing operations corresponding to manipulations with respect to the mobile terminal of FIG. 5.

As shown in FIGS. 12 to 22, the controller 180 of the mobile terminal according to an embodiment of the present invention may control operations of the mobile terminal correspondingly according to various user's touch operations.

As shown in FIG. 12, the controller 180 of the mobile terminal 100 may convert text (T) into speech and output the same.

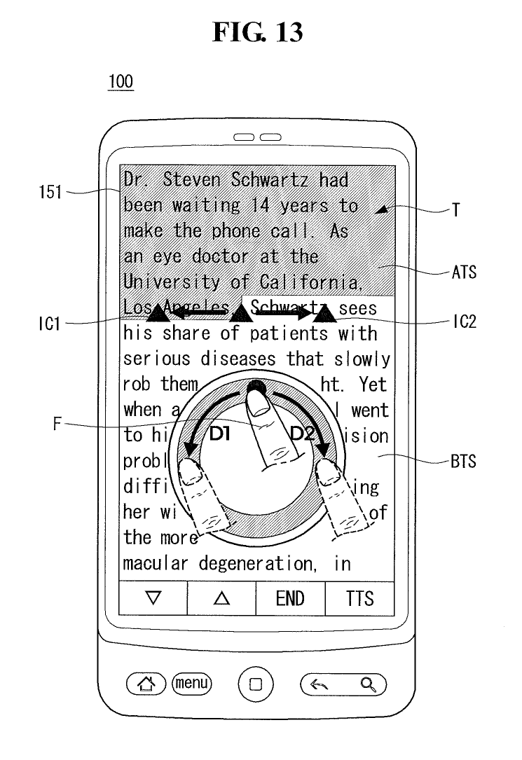

As shown in FIG. 13, the user may perform a touch operation of touching the display module 151 and performing first and second drags D1 and D2 in the process of outputting speech.

The first and second drags D1 and D2 may be circular drags. Namely, it means that, with his finger (F) put on the display module 151, the user may rotate his finger from the touched position in a clockwise or counterclockwise direction to perform a drag operation.

When the first and second drags D1 and D2 for a rotation in the clockwise or counterclockwise direction are input, the controller 180 may move and display the indicator IC corresponding to the directions. Namely, it means that a reproduced position can be moved to a front side or rear side of a current position.

The positions, or the like, of the moved first and second indicators IC1 and IC2 may vary according to the length, speed, or the like, of the first and second drags D1 and D2. For example, when the first drag D1 is performed faster than a reference speed or is performed to be longer, it means that the first indicator IC1 may be moved by paragraph. In comparison, when the first drag D1 is performed slower than a reference speed or is performed to be shorter, it means that the first indicator IC1 may be moved by word.

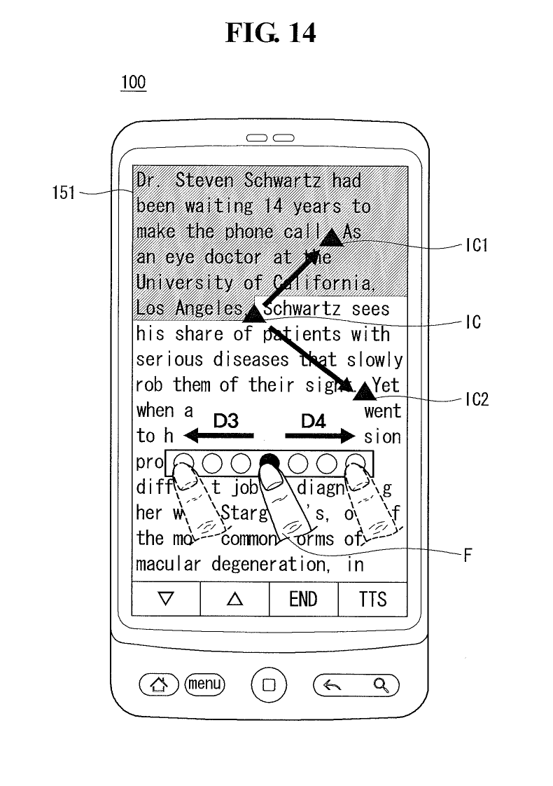

As shown in FIG. 14, the user may touch the display module 151 to perform drags D3 and D4 in the process of outputting speech.

The third and fourth drags D3 and D4 may be drag operations to move to the left or right starting from the first touched position of the user's finger (F), or the like.

When the third and fourth drags D3 and D4 moving to the left or right are input, the controller 180 may move the indicator IC by sentence to display it. Namely, it means that the controller 180 may move the indicator IC to a front sentence or a rear sentence of a sentence being currently reproduced to output speech.

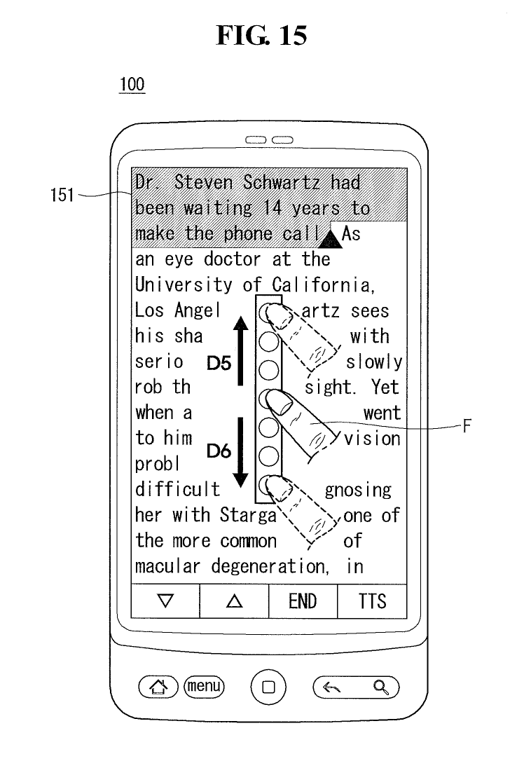

As shown in FIG. 15, the user may perform a touch operation of touching the display module 151 and performing fifth and sixth drags D5 and D6 in the process of outputting speech.

The fifth and sixth drags D5 and D6 may be drags in a vertical direction. Namely, the user may perform a drag operation upwardly or downwardly starting from a first touched position of the user's finger (F), or the like.

When the fifth and sixth drags D5 and D6 of dragging upwardly or downwardly are input, the controller 180 may change a playing speed of speech. It means, for example, that when the fifth drag D5 is input, the playing speed may become fast, and when the sixth drag D6 is input, the playing speed may become slow. The fifth and sixth drags D5 and D6 of dragging upwardly or downwardly may correspond to a function of adjusting a sound volume.

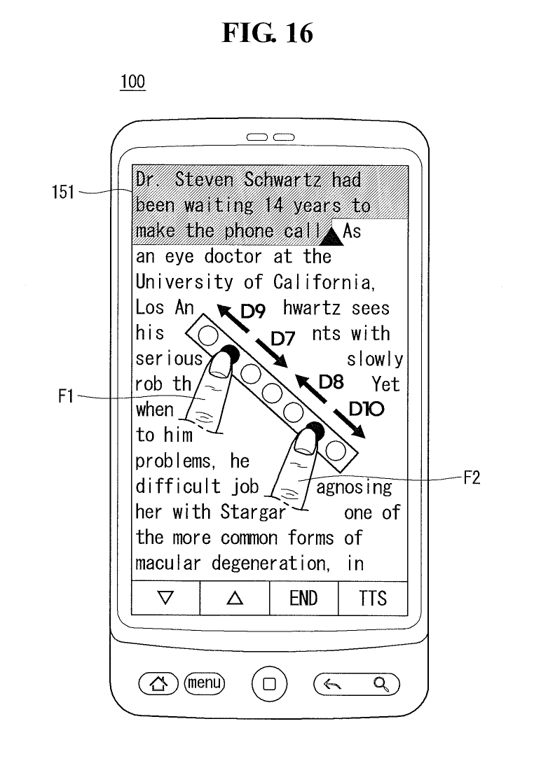

As shown in FIG. 16, the user may perform a touch operation of multi-touching the display module 151 and performing seventh to tenth drags D7 to D10 in the process of outputting speech.

The seventh to tenth drags D7 to D10 may be a touch operation for decreasing or increasing the distance between the multi-touched first and second fingers F1 and F2.

When the seventh to tenth drags D7 to D1 for increasing or decreasing the distance between the first and second fingers F1 and F2 are input, the controller 180 may change a playing speed of speech.

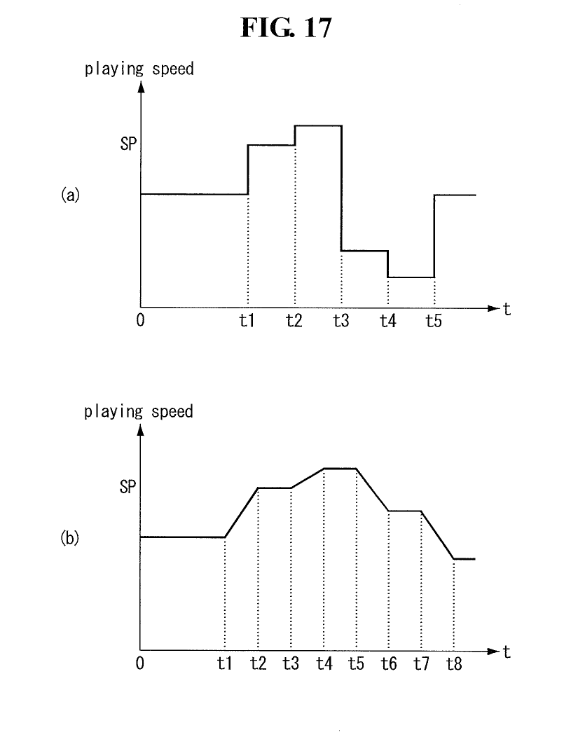

As shown in FIG. 17, the playing speed of speech may be changed into mutually different forms according to pre-set values.

As shown in FIG. 17(a), the user may perform an operation of changing the playing speed of speech at points in time t1 to t5. When the operation of changing the playing speed of speech is input from the user, the controller 180 may provide control to rapidly change the playing speed at a corresponding point in time. Namely, it means that when an existing playing speed is v1, the playing speed may be rapidly shifted into a changed playing speed v2.

As shown in FIG. 17(b), the user may perform an operation of changing the playing speed of speech at points in time t1, t3, t5, and t7. When the operation of changing the playing speed of speech is input from the user, the controller 180 may gradually increase or decrease the playing speed of speech starting from the corresponding points in time. It means, for example, that when the user performs a touch operation to increase the playing speed of speech at the point in time t1, the controller 180 may provide control to gradually increase the playing speed of speech until the point in time t2.

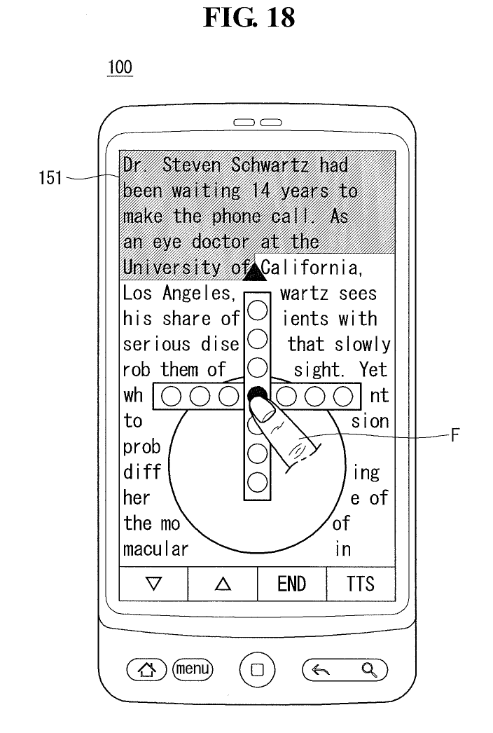

As shown in FIG. 18, in a state in which the user touches a particular point of the display module 151 with his finger (F), the user may appropriately perform a desired touch operation. For example, the user may perform dragging in a clockwise or counterclockwise direction, in a vertical direction, or in a horizontal direction. The controller 180 may perform a particular function corresponding to the direction of the user's dragging operation.

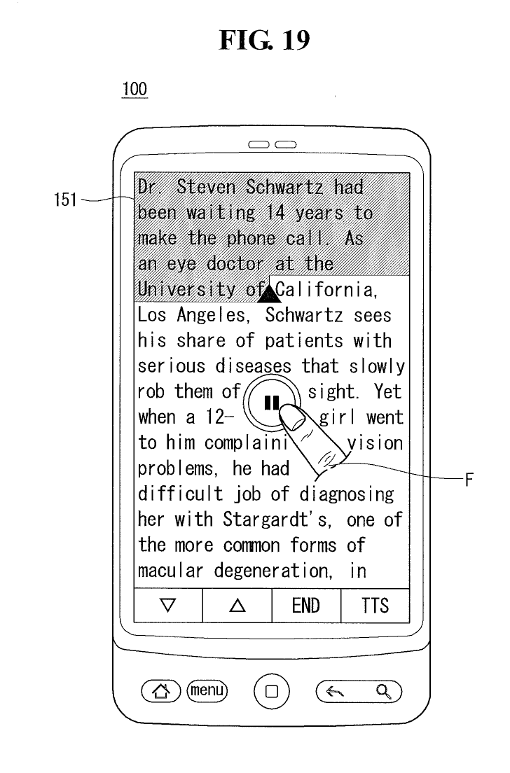

As shown in FIG. 19, the user may perform an operation of touching a particular point of the display module 151 with his finger (F) in the process of outputting speech.

When the user touches a particular point of the display module 151 with his finer (F) while speech is being output, the controller 180 may stop outputting of speech. In addition, when the user touches again the display module 151 in the stopped state, the controller 180 may provide control to perform outputting of speech again.

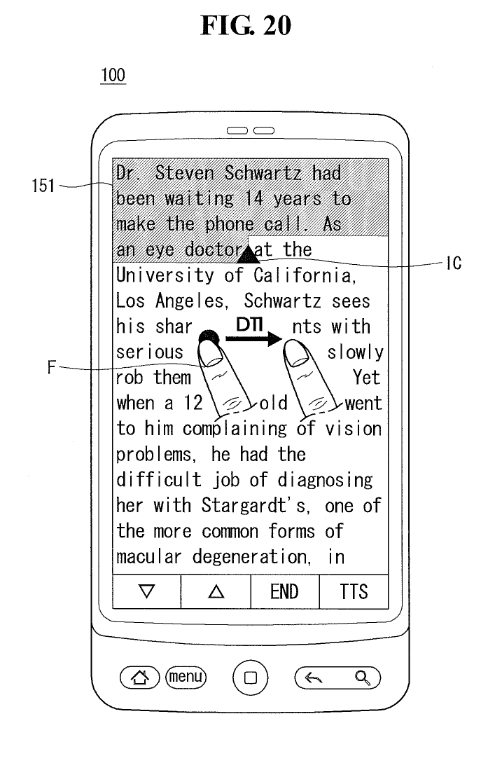

As shown in FIG. 20, in a state in which a speech output is stopped, a touch operation of touching the display module 151 and performing an eleventh drag D11 may be performed.

The eleventh drag D11 may be a touch operation of dragging to the left in a state in which one point is being touched. When such a touch operation is performed, the controller 180 may provide control to output speech starting from the touched point.

When speech is output starting from the touched point, the controller 180 may move the indicator IC to the touched point and display it.

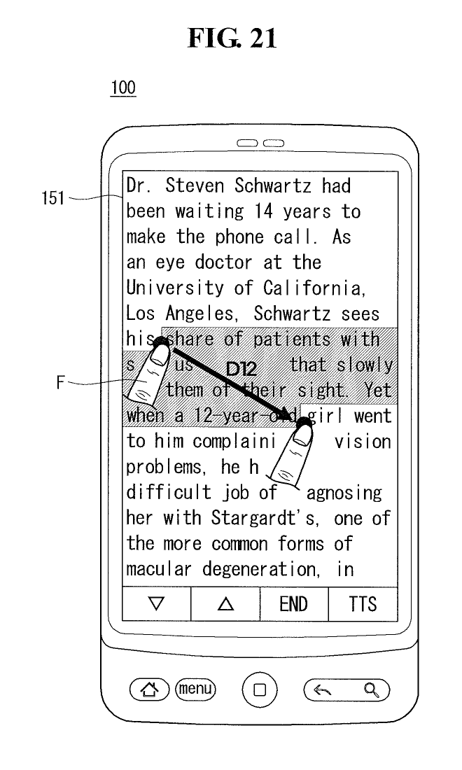

As shown in FIG. 21, in a state in which a speech output is stopped, a touch operation of touching the display module 151 and performing a twelfth drag D12 by a certain distance may be performed.

The twelfth drag D12 may be a touch operation of dragging to a desired end point in a state in which the user touches one point. When such a touch operation is performed, the controller 180 may convert text within the range included in the twelfth drag D12 into speech and output the same. Namely, the twelfth drag D12 may be a touch operation to select a section to be output by speech.

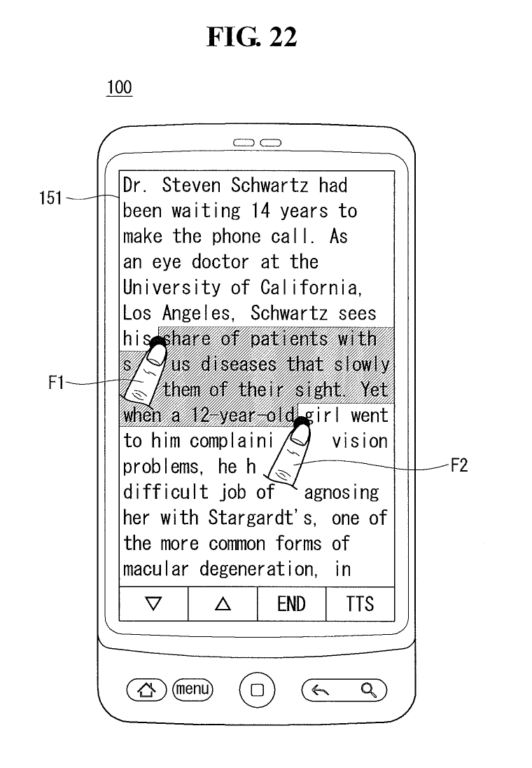

As shown in FIG. 22, in a state in which a speech output is stopped, a touch operation of multi-touching the display module 151 may be performed.

The first and second fingers F1 and F2 performing multi-touch may be an operation of touching a start point and an end point of a section to be output by speech. When the multi-touch using the first and second fingers F1 and F2 is performed, the controller 180 may output text within the corresponding section.

The case in which particular functions are matched to particular touch operations has been described with reference to FIGS. 12 to 22 for the sake of understanding. However, of course, a different function may be matched to a particular touch operation. For example, a function of changing the size of the sound volume may be matched to the first and second drags D1 and D2.

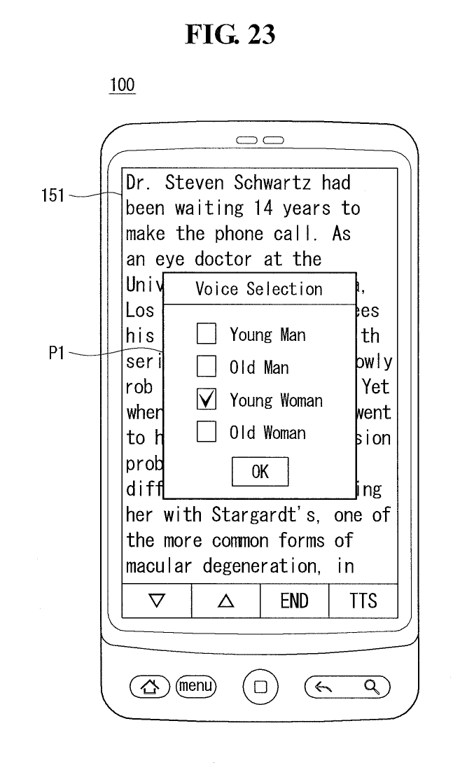

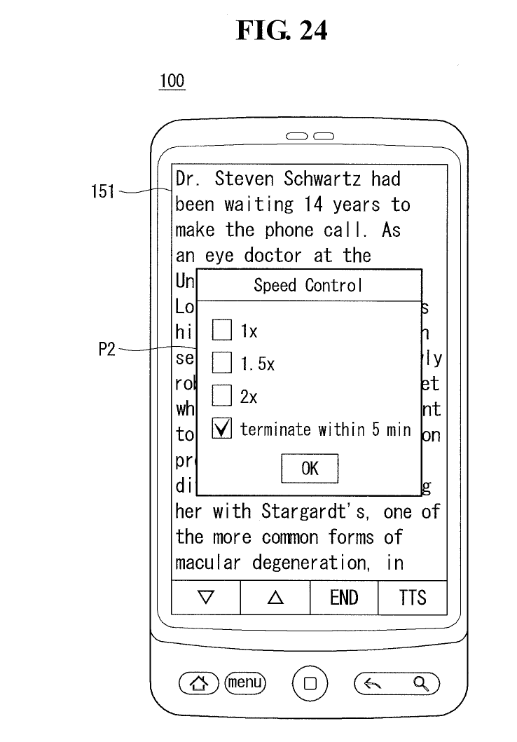

FIGS. 23 and 24 are views showing manipulations with respect to a setting of the mobile terminal of FIG. 5.

As illustrated in FIGS. 23 and 24, the controller 180 of the mobile terminal 100 according to an embodiment of the present invention may change the state in which speech is output.

As shown in FIG. 23, a first pop-up window P1 for selecting the type of speech may be displayed on the display module 151. For example, a particular speech may be selected from among young man, old man, young woman, and old woman.

As shown in FIG. 24, a second pop-up window P2 for selecting a playing speed of speech may be displayed on the display module 151. It means, for example, that a particular speed can be directly selected. In addition, the selective options of the playing speeds may include an option for terminating a speech output with respect to text selected within a certain time. It means, for example, that an output of speech with respect to a corresponding portion may be terminated within five minutes.

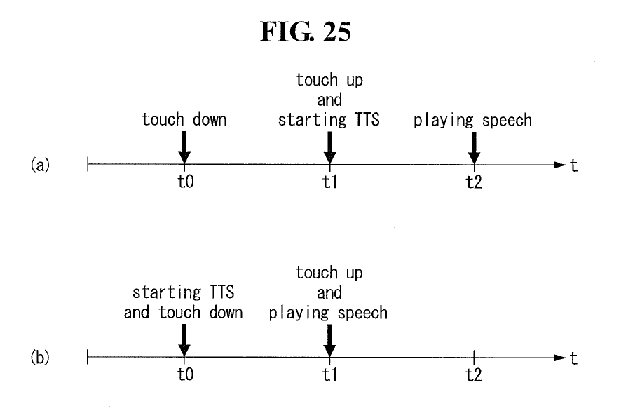

FIGS. 25 to 27 are views showing operations of the mobile terminal of FIG. 5.

As illustrated in FIGS. 25 to 27, the controller 180 of the mobile terminal according to an embodiment of the present invention may perform the TTS function in advance when a user's touch operation is performed to thus minimize time delay.

As shown in FIG. 25(a), a touch-down of touching the display module 151 by the user in order to execute a particular function at a point in time t0 may take place. The touch operation may be divided into a simple touch that, after a position is touched down, the touch is up from the position, a drag touch that, a position is touched down, the touched-down position is continuously moved and then the touch is up at a particular position, and a long touch that, a position is touched down, the touched-down state is maintained at the corresponding position for more than a certain period of time, and then, the touch is up, and the like.

A determination of the controller 180 as to for which function a touch operation is to be performed may be made after a touch-up signal is input, as described above. Thus, in the related art TTS system, when a touch-down operation is input at the point in time to, it waits until the point in time t1 at which a touch-up operation is input, and then, the TTS operation is started. When the TTS operation is started at the point in time t1, an array of preparation operations are performed, and then, speech output may start at the point in time t2. Thus, time delay, from the point in time t0 at which the user intends to perform the TTS operation to the point in time t2 at which speech is actually output, occurs.

In comparison, as shown in FIG. 25(b), the TTS system according to an embodiment of the present invention may start the TTS operation immediately when a touch-down signal is input at the point in time t0. Thus, when a touch-up signal is input at the point in time t1, speech output can start at the substantially same time or within a very short time. As a result, the effect of reducing time delay by the time from t1 to t2 can be achieved.

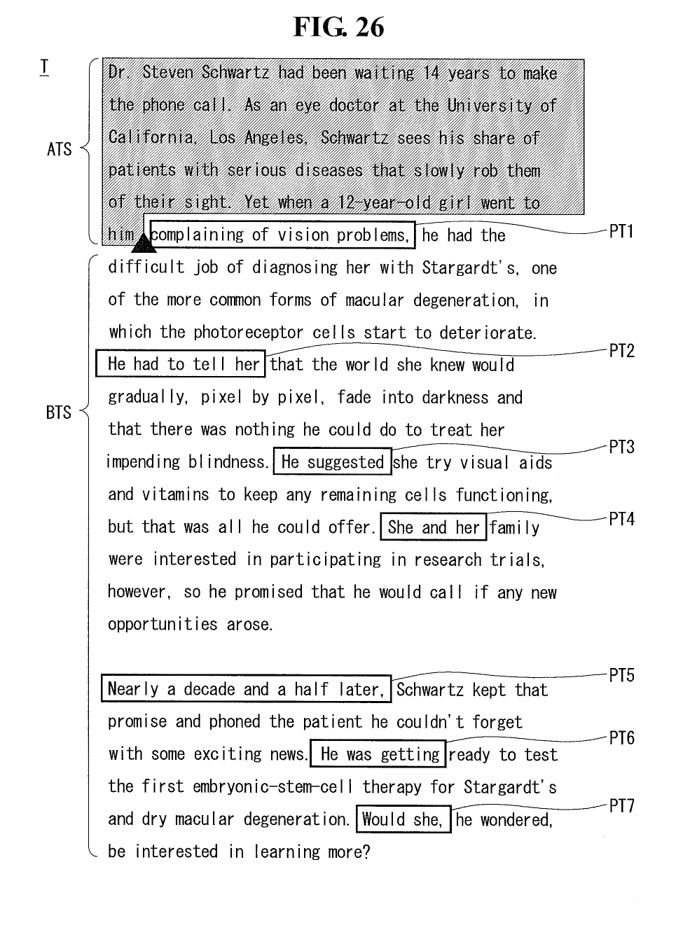

As shown in FIG. 26, the controller 180 of the mobile terminal 100 according to an embodiment of the present invention may be performing a speech output with respect to the text (T), or the speech output may be stopped at a particular point.

In a particular state, the user may touch the display module 151 with his finger (F). It means, for example, that the controller 180 may obtain a touch-down signal.

The user's touch of the display module 151 in a state in which the speech output is being performed or is stopped man mean that the user may intend to resume the speech output or to move to a particular point to output speech. Thus, when the touch-down signal is obtained, the controller 180 may perform the TTS operation on a portion of part which has not been reproduced yet.

First to seventh conversion areas PT1 to PT7 may be TTS operation performance areas which have been previously performed by the controller 180 according to the user's touch-down signal. By performing the TTS conversion in advance on the certain areas of front portions of particular sentences which have not been reproduced yet, the user can quickly output speech when he selects one of the first to seventh conversion areas PT1 to PT7.

The first to seventh conversion areas PT1 to PT7 may belong to the non-output part BTS which has not been output by speech yet. Namely, in the case of the output part ATS in which speech data which has been output by speech exists, when the user selects the output part ATS, the output part ATS can be quickly output by speech any time. In comparison, when a particular point of the non-output part BTS is selected, since corresponding speech data does not exist, time delay may occur due to a prior operation for outputting speech. The mobile terminal 100 according to an embodiment of the present invention can minimize such time delay by converting certain areas of the non-output part BS in advance.

The first to seventh conversion areas PT1 to PT7 may be portions which are highly likely to be selected by the user in the non-output part BTS. For example, the first to seventh conversion areas PT1 to PT7 may be a first portion of an independent sentence, a first portion of a paragraph, a point previously designated by the user as a bookmark, or the like, or a portion which has been repeatedly selected by the user in the past.

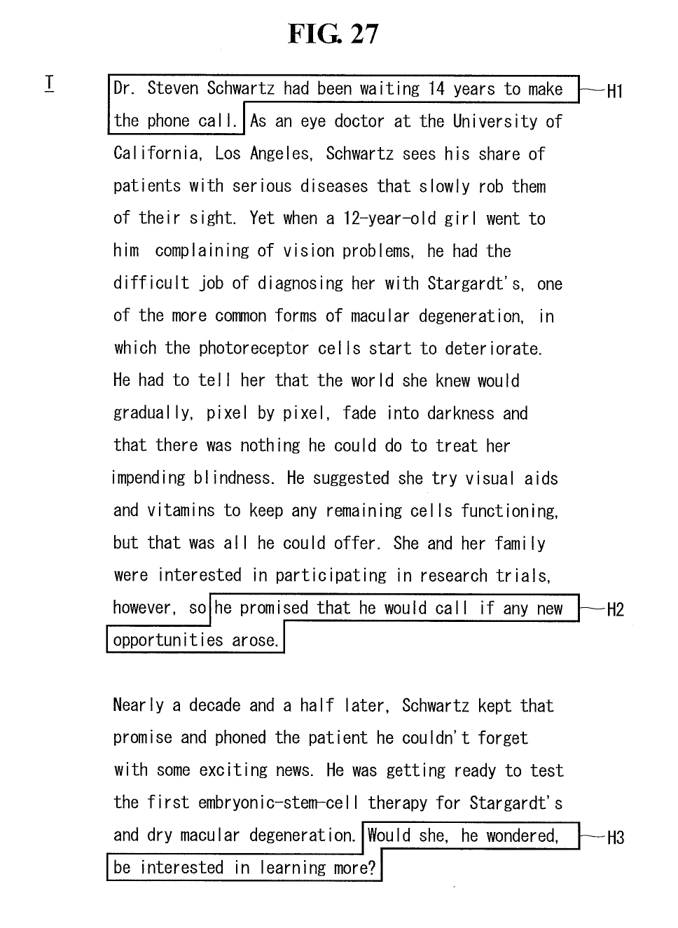

As shown in FIG. 27, the controller 180 of the mobile terminal 100 according to an embodiment of the present invention may perform speech output with respect to highlighted areas H1 to H3.

The first to third highlighted areas H1 to H3 may be areas selected by the user. In addition, the first to third highlighted areas H1 to H3 may be information obtained through the wireless communication unit 110.

The first to third highlighted areas H1 to H3 may be portions designated to be important by the user or may be portions tagged to be significant by the user.

For the first to third highlighted areas H1 to H3, the controller 180 may store corresponding speech data through TTS in advance regardless of whether or not the areas have been reproduced. The first to third highlighted areas H1 to H3 are highly likely to be reproduced by the user. Thus, by storing the speech data corresponding to the first to third highlighted areas H1 to H3, the areas can be reproduced without any time delay when the user selects the areas.

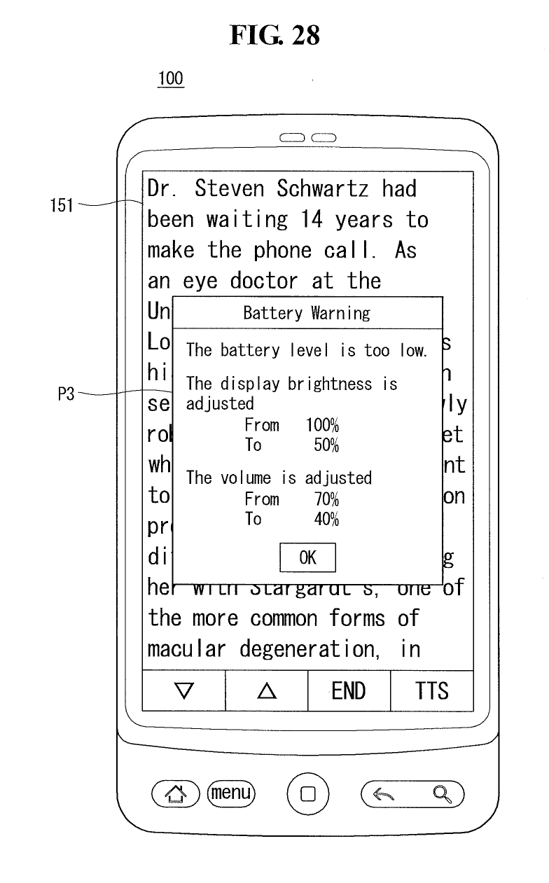

FIG. 28 is a view showing an operation related to a battery of the mobile terminal of FIG. 5.

As illustrated in FIG. 28, the controller 180 of the mobile terminal 100 according to an embodiment of the present invention may control a speech output in relation to the remaining battery capacity of the mobile terminal 100.

The controller 180 may determine whether or not a charged amount of the battery is lower than a pre-set certain level. When the charged amount of the battery is lower than the certain level, the controller 180 may adjust the brightness of the display module 151 and/or the sound volume of the audio output module 152. The controller 180 may sequentially reduce the brightness of the display module 151 and/or the sound volume of the audio output module 152 according to the charged amount of the battery.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

A mobile terminal may include a first touch screen configured to display a first object, a second touch screen configured to display a second object, and a controller configured to receive a first touch input applied to the first object and to link the first object to a function corresponding to the second object when receiving a second touch input applied to the second object while the first touch input is maintained.

A method may be provided of controlling a mobile terminal that includes displaying a first object on the first touch screen, displaying a second object on the second touch screen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of this document. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal comprising:
an audio output module;
a storage medium configured to store text; and
a controller configured to:
receive selection of a portion of the text to output as speech;
convert the portion of the text into speech data;
output, through the audio output module, speech for the portion of the text based on the speech data;
store, in the storage medium and in association with identification data for the portion of the text, the speech data for the portion of the text obtained by converting the portion of the text into speech data; and
handle a second outputting of the portion of the text as speech by:
accessing, from the storage medium, the speech data for the portion of the text based on the identification data for the portion of the text; and
using the accessed speech data to output, through the audio output module, speech for the portion of the text without having to perform another conversion of the portion of the text into speech data.

2. The mobile terminal of claim 1:
wherein the storage medium is configured to store a database including at least one type of recorded speech data among at least one phone, at least one diphone, at least one syllable, at least one morpheme, at least one word, at least one phrase, at least one clause, and at least one sentence, and
wherein the controller is configured to generate the speech data by combining parts of the recorded speech data that correspond to the portion of the text.

3. The mobile terminal of claim 2, wherein the controller is configured to store, in the storage medium, the speech data generated by combining the parts of the recorded speech data, and, when the portion of the text is repeatedly output, the controller is configured to output speech based on the stored speech data generated by combining the parts of the recorded speech data without combining the parts of the recorded speech data again.

4. The mobile terminal of claim 1, wherein the controller is configured to change reproduction attributes of speech based on receipt of a touch signal.

5. The mobile terminal of claim 4, wherein the reproduction attributes are at least one of a position in the text from which speech is output, a range for outputting speech in the text, whether or not speech is repeatedly output, whether or not speech is output, a sound volume of speech, an output speed of speech, and a pitch of speech.

6. The mobile terminal of claim 4, wherein the controller is configured to change the reproduction attributes according to at least one of a direction, a distance, and a duration of the touch signal.

7. The mobile terminal of claim 1, wherein the controller is configured to display an indicator that indicates a position of the text at which speech is output.

8. The mobile terminal of claim 7, wherein the controller is configured to receive a touch signal for changing the position of the indicator and, based on the touch signal for changing the position of the indicator, output text corresponding to the changed position of the indicator as speech.

9. The mobile terminal of claim 1, wherein the controller is configured to display the portion of the text which has been output as speech differently than another portion of the text which has not been output as speech.

10. The mobile terminal of claim 1, wherein the controller is configured to determine that the portion of the text is to be output as speech within a pre-set amount of time and, based on the determination that the portion of the text is to be output as speech within the pre-set amount of time, adjust an output speed such that the portion of the text is output as speech within the pre-set amount of time.

11. The mobile terminal of claim 1, wherein the controller is configured to detect a touch signal and start a speech conversion process with respect to the portion of the text based on detection of the touch signal.

12. The mobile terminal of claim 11, wherein the controller is configured to start the speech conversion process with respect to at least two separated areas in the portion of the text based on detection of the touch signal.

13. The mobile terminal of claim 11, wherein the controller is configured to start the speech conversion process with respect to a part of the portion of the text which has not previously been outputted as speech based on detection of the touch signal.

14. A mobile terminal comprising:
an audio output module;
a storage medium configured to store text; and
a controller configured to:
convert a portion of the text into speech data;
output, through the audio output module, speech for the portion of the text based on the speech data;
receive a signal for re-outputting at least a portion of the output speech;
re-output the portion of the output speech by:
accessing, from the storage medium, speech data for the portion of the output speech; and
using the accessed speech data to output, through the audio output module, the portion of the output speech.

15. The mobile terminal of claim 14:
wherein the storage medium is configured to store a database including at least one type of recorded speech data among at least one phone, at least one diphone, at least one syllable, at least one morpheme, at least one word, at least one phrase, at least one clause, and at least one sentence, and
wherein the controller is configured to generate the speech data by combining parts of the recorded speech data that correspond to the portion of the text.

16. The mobile terminal of claim 14, wherein the controller is configured to change reproduction attributes of speech based on receipt of a touch signal.

17. The mobile terminal of claim 16, wherein the controller is configured to change the reproduction attributes according to at least one of a direction, a distance, and a duration of the touch signal.

18. The mobile terminal of claim 14, wherein the controller is configured to display an indicator that indicates a position of the text at which speech is output.

19. The mobile terminal of claim 14, wherein the controller is configured to display the portion of the text which has been output as speech differently than another portion of the text which has not been output as speech.

20. The mobile terminal of claim 14, wherein the controller is configured to detect a touch signal and start a speech conversion process with respect to the portion of the text based on detection of the touch signal.

21. A method for outputting speech, the method comprising:
receiving selection of a portion of text to output as speech;
converting the portion of the text into speech data;
outputting, through an audio output module, speech for the portion of the text based on the speech data;
storing, in a storage medium and in association with identification data for the portion of the text, the speech data for the portion of the text obtained by converting the portion of the text into speech data; and
handling a second outputting of the portion of the text as speech by:
accessing, from the storage medium, the speech data for the portion of the text based on the identification data for the portion of the text; and
using the accessed speech data to output, through the audio output module, speech for the portion of the text without having to perform another conversion of the portion of the text into speech data.

22. The method of claim 21, wherein converting the portion of the text into speech data and outputting, through an audio output module, speech for the portion of the text based on the speech data comprises combining parts of recorded speech data that correspond to the portion of the text using at least one type of recorded speech data among at least one phone, at least one diphone, at least one syllable, at least one morpheme, at least one word, at least one phrase, at least one clause, and at least one sentence stored in a database, and converting the combined parts of recorded speech data into the speech data.

23. The method of claim 21, further comprising:
obtaining a touch signal; and
changing output attributes of speech based on the obtained touch signal.

24. The method of claim 21, further comprising:
displaying an indicator that indicates a position in the text at which speech is output.

25. The method of claim 21, further comprising:
displaying the portion of the text which has been output as speech differently than another portion of the text which has not been output as speech.

26. The method of claim 21, wherein converting the portion of the text into speech data comprises detecting a touch signal and starting a speech conversion process with respect to the portion of the text based on detection of the touch signal.
